(19) United States
(12) Patent Application Publication
(10) Pub. No.: US 2025/0308251 A1
(43) Pub. Date: Oct. 2, 2025

(54) SYSTEMS AND METHODS FOR DETECTING OBJECTS IN AGRICULTURAL FIELDS

(71) Applicant: Raven Industries, Inc., Sioux Falls, SD (US)

(72) Inventors: Aikaterini Karakoula, Athens (GR); Georgios-Taxiarchis Glannios, Attiki (GR); Spyridon Evangelatos, Attiki (GR); Alexandros Emmanouill Nikolakakis, Attiki (GR)

(21) Appl. No.: 19/073,614

(22) Filed: Mar. 7, 2025

(30) Foreign Application Priority Data
Mar. 26, 2024 (GR) 20240100219

(51) Int. Cl. G06V 20/58; A01C 21/00; A01M 99/00; G06T 7/70; H04N 23/12

(52) U.S. Cl. CPC G06V 20/58; A01C 21/007; G06T 7/70; H04N 23/12; A01M 99/00

(57) ABSTRACT

Systems and methods discussed herein can use an observation count data structure to help track field features and identify areas for treatment. The system can use the observation information to determine whether or to what extent to treat particular field areas (e.g., with pesticide, or other material). For example, unobserved areas can be treated with a fixed dosage, while other areas can be treated with a dosage tailored to the particular features observed in the field area.

### CLAIMS OF PRIORITY

This patent application claims the benefit of priority application Ser. No. 20240100219, titled “SYSTEMS AND METHODS FOR DETECTING OBJECTS IN AGRICULTURAL FIELDS,” filed Mar. 26, 2024, with the Hellenic Industrial Property Organization (OBI) in Greece, which is hereby incorporated herein in its entirety.

### TECHNICAL FIELD

This document pertains generally, but not by way of limitation, to detecting, identifying, and localizing objects in agricultural fields for controlling agricultural vehicles and implements.

### BACKGROUND OF THE INVENTION

Agricultural sprayers apply agricultural products for the husbandry of crops or field. For instance, sprayers apply fertilizers, herbicides, pesticides or the like to remove unwanted pests such as weeds and insects and support the growth of crops. Agricultural sprayers include product reservoirs, sprayer booms and spray nozzles along the sprayer booms.

### SUMMARY OF THE INVENTION

In some examples, broad application of agricultural products may have a negative impact on multiple fronts, such as the cost of the field operation (agricultural products are expensive), the environmental effects, and residual chemicals in the harvested crops. Thus, there is an ongoing global effort to reduce the use of chemicals applied. The present inventors have recognized, among other things, that a problem to be solved can include excessive chemical application.

Techniques for controlling the application of agricultural products (e.g., chemicals) in agriculture are described herein. The techniques described herein can include detecting objects in a field, determining how many times an area has been observed, and controlling application of the agricultural product accordingly.

A system to detect field objects, such as weeds and other unwanted plants, and index those field objects in an agricultural field is described below. In some examples, an imaging sensor can be mounted on the roof of an agricultural vehicle, such as an agricultural sprayer. The imaging sensor can include a stereoscopic multispectral imaging sensor configured to capture images of the agricultural field in real-time (i.e., as the agricultural vehicle is moving around the field). The system can detect objects (e.g., weeds, crops, pests or the like) based on the multispectral imaging information. For example, the system can perform “green on brown” detection to detect plants (e.g., objects with high vegetation index) in a brown field. For example, the system can detect “green” weeds against a “brown” background using color differentiation The system can index identified objects, such as determining location of the objects (e.g., coordinates, cell location). The system can also determine how many times respective locations in the field have been observed by the imaging system, for instance to enhance the confidence of green on brown detection and associated indexing of plants in the field for targeted agricultural product application. The system can use this observation count information to determine whether to apply an agricultural product, such as a chemical product. This observation count information can be used to detect false positives of objects. For example, a single detection of an object (e.g., weed) in an area that has been observed multiple times before with no other object detection can be classified as a false positive and no additional chemical product may be applied based on that single detection. In some examples, for previously unobserved areas having a first observation with a detected object (e.g., weed, pest or the like), the system can apply a fixed dosage (e.g., specified amount, maximum dosage or bolus, minimum dosage or bolus or the like) of the agricultural product. In some examples, for areas having only been observed once, a detected object (e.g., weed, pest or the like) will be treated with an increased dosage (e.g., specified amount, maximum dosage or bolus) of the agricultural product. That is because no confident assessment of whether the detection is a false positive can be done based on so few observations of the area.

In some examples, in response to detection of an unobserved area, a fixed dosage, such as a safe dosage or zero dosage, of the agricultural product can be applied. An unobserved area can occur for different reasons. For example, detection of an unobserved area can occur if the detection algorithm encounters an error, if the detection algorithm cannot generate a confident assessment, if the agricultural vehicle (e.g., tractor) is turning on, if the detection algorithm has just started, etc. Therefore, applying a safe dosage when an unobserved area is detected can prevent the system from leaving undetected objects untreated.

Described herein is a method comprising: receiving real-time image information of a field from a multi-spectral imaging system positioned on an agricultural vehicle; determining, by at least one hardware processor, an observation count for a location in the field, wherein the observation count represents a number of times the location has been observed by the multi-spectral imaging system; and determining an amount of an agricultural product to apply to the location by the agricultural vehicle based on the observation count.

Also described herein is a system comprising a least one hardware processor and at least one memory storing instructions that, when executed by the at least one hardware processor, cause the at least one hardware processor to perform operations comprising: receiving real-time image information of a field from a multi-spectral imaging system positioned on an agricultural vehicle; determining an observation count for a location in the field, wherein the observation count represents a number of times the location has been observed by the multi-spectral imaging system; and determining an amount of an agricultural product to apply to the location by the agricultural vehicle based on the observation count.

Further described herein is machine-storage medium embodying instructions that, when executed by a machine, cause the machine to perform operations comprising: receiving real-time image information of a field from a multi-spectral imaging system positioned on an agricultural vehicle; determining an observation count for a location in the field, wherein the observation count represents a number of times the location has been observed by the multi-spectral imaging system; and determining an amount of an agricultural product to apply to the location by the agricultural vehicle based on the observation count.

This Summary is intended to provide an overview of subject matter of the present patent application. It is not intended to provide an exclusive or exhaustive explanation of the topics discussed herein. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a side view of an example imaging system for an agricultural vehicle, in accordance with aspects of the present disclosure.

FIG. 2 is a block diagram of one example of a controller configured for use with the imaging system of FIG. 1, in accordance with aspects of the present disclosure.

FIG. 3 is a perspective view of the imaging system of FIG. 1, in accordance with aspects of the present disclosure.

FIG. 4 is a top view of the imaging system of FIG. 1, in accordance with aspects of the present disclosure.

FIG. 5 is a side view of the imaging system of FIG. 1, in accordance with aspects of the present disclosure.

FIG. 6 is a flow diagram of a method for controlling the amount of agricultural product to be applied based on observation counts, in accordance with aspects of the present disclosure.

FIG. 7 shows an example of an observation page, in accordance with aspects of the present disclosure.

FIG. 8 shows an example of a page coordinate system, in accordance with aspects of the present disclosure.

FIG. 9 shows an example of an observation page, in accordance with aspects of the present disclosure.

FIG. 10A-D show an example of selective activation of different observation pages in an observation matrix, in accordance with aspects of the present disclosure.

FIG. 11 is a flow diagram of a method using observation pages to control the amount of agricultural product to be applied based on observation counts in accordance with aspects of the present disclosure.

FIG. 12 shows an example of using a field of view to increment observation counts, in accordance with aspects of the present disclosure.

FIG. 13A-D show an example of using observation counts based on a field of view as an agricultural vehicle traverses a field, in accordance with aspects of the present disclosure.

FIG. 14 shows an illustration example of querying an observation matrix for a plurality of areas, in accordance with aspects of the present disclosure.

FIG. 15 shows a block diagram of an example comprising a machine upon which any one or more of the techniques (e.g., methodologies) discussed herein may be performed.

### DETAILED DESCRIPTION OF THE DRAWINGS

The present disclosure relates to detecting, identifying, localizing, and/or determining the characteristics of field elements and/or field morphology in agricultural fields. In an example, the systems and methods discussed herein can enable more efficient use of chemical products when spraying an agricultural field.

Aspects of the present disclosure are described in detail with reference to the figures, wherein like reference numerals identify similar or identical elements.

Although the present disclosure will be described in terms of specific aspects and examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the figures, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

Currently, it is challenging to accurately detect, identify, localize, and determine the characteristics of field elements in agricultural fields for the entire working width of agricultural equipment. As used herein, “working width” includes the width in which a chemical or other material is sprayed or released from an agricultural implement, for example, as the implement moves. In order to cover the entire working width with the desired accuracy, multiple components are typically used, making the resulting system complex, expensive, and difficult to install. The systems and methods discussed herein are configured to provide information about field elements, for example using existing or retrofitted hardware that can be coupled to existing agricultural equipment. In some examples, the hardware discussed herein can be mounted on the roof of the agricultural equipment. This way, the installation effort is minimized, as well as the associated cost.

In an example, the disclosed technology provides means for agricultural equipment to apply chemical substances on fields where needed, at the needed amount. In some cases, agricultural equipment applies a fixed amount of chemical substance (per specific area) because the equipment is not configured to determine, in real-time and during operation, where and how much chemical to apply.

Some systems include or use sensing/imaging devices that are mounted along a spraying boom (in some solutions, one device per spray nozzle is used). The sensing devices normally face downwards and in the front of the spray boom in order to detect plants and control the spray valve in order to apply the needed chemicals. The sensing elements also include their own light sources (i.e., are active sensors). Although providing the sensing device close to the field surface provides benefits in terms of accuracy and direct control of the spray valve, there are several drawbacks to this implementation. Since each device corresponds to an operating width of less than a few meters (typically about 0.5 to about 1.5 meters), multiple devices are needed for installing such systems on an average sprayer. Typical sprayers are in the range of about 32 to about 42 meters wide. The need for more than 20 (typically 40 to 80 devices) per sprayer makes such a solution very costly, as a single device includes an environmentally sealed enclosure, a sensor, a processing unit, and a controller for the spray valve. The high cost of such solutions is, in most cases, not justified when compared to the benefit it brings. The installation of such a system involves mounting the devices on the boom, therefore making the installation time intensive and complex. In many cases, the boom needs to be entirely replaced. The devices are mounted close to the spray nozzles, which results in the need to remove chemical residue, dirt, or other debris that may cover the sensing elements and interfere with their measurements.

The presently disclosed technology provides various benefits, including improving and optimizing agricultural operations. For example, the systems and methods discussed herein can be used to help reduce chemical usage by modifying in real-time the dosage of an applied substance. The systems and methods discussed herein can be configured to determine the required dosage by detecting and identifying field elements, localizing field elements, determining characteristics of field elements, and/or determining how many times those field elements have been detected in real-time.

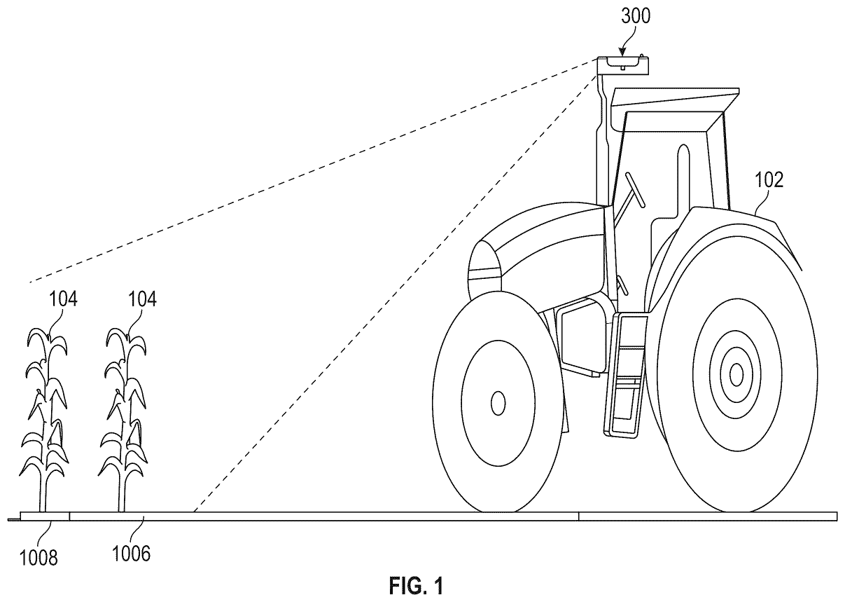

Referring to FIG. 1, a side view of an imaging system 300 configured for detecting or identifying field elements, localizing field elements, determining characteristics of field elements, and/or determining field morphology in agricultural fields in real-time. The imaging system 300 is configured to capture real-time images of field elements 104 (e.g., crops, weeds) and/or fields 1006 and may be mounted on an agricultural vehicle 102, such as a tractor or other agricultural equipment. In an example, the agricultural equipment can be configured for applying chemical (or any other) substances to a crop field or any other agricultural land, or for performing other operations in the field like monitoring the field, harvesting, tilling, etc.). The agricultural vehicle 102 may include, for example, farming equipment, a farming vehicle, an agricultural operations vehicle, and/or a tractor. In an example, the agricultural vehicle 102 is configured to perform at least one agricultural operation on the field elements 104. The agricultural operation may include harvesting, sowing, tilling, fertilizing, etc. In an example, the agricultural vehicle 102 may include a plurality of spraying nozzles (not shown) configured for applying a substance (such as fertilizer or weed killer), one or more actuators (not shown) for controlling the amount of substance to be sprayed, and a controller (not shown) configured for controlling the actuators.

A benefit of the imaging system 300 being mounted on the roof or other high point of agricultural vehicle 102 is that the imaging system 300 is less affected by chemical residue, dirt, and other factors that interfere with the sensing elements of systems that are mounted close to the nozzles that apply chemicals.

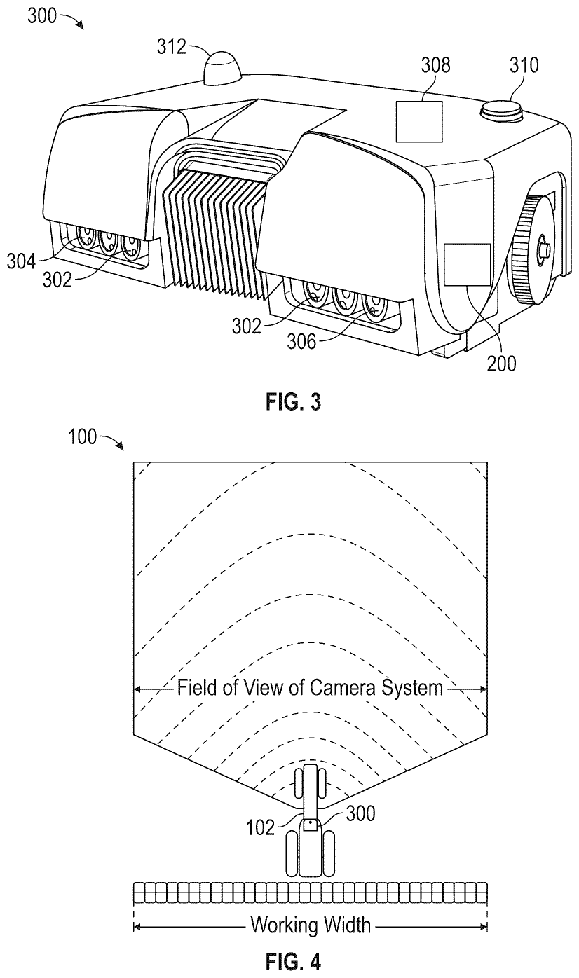

The imaging system 300 is configured to be usable with the agricultural vehicle 102, as the agricultural vehicle 102 moves through a field 1006. In an example, information received by the imaging system 300 can be used to measure the field elements 104 of the field 1006, and/or elements in one or more other fields 1008. In an example, the imaging system 300 includes a front-facing (as opposed to downwards-facing in other solutions) wide-lens, stereoscopic imaging sensor 302 (see, e.g., FIG. 3).

The imaging system 300 can be configured to detect, identify, and determine the exact location of field elements 104 in the field 1006. In an example, the imaging system 300 can receive information about the field elements 104 over at least an entire working width of the agricultural machinery in real-time. In an example, a controller that is coupled to, or comprises a portion of the imaging system 300, can be configured to use information from the imaging system 300 to control various machinery. In an example, the imaging system 300 is configured to capture information and calculate field morphology by combining information from one or more cameras, stereo cameras, or other sensors. In various aspects, the determined location of the field elements 104 may be relative or absolute.

The imaging system 300 is configured to improve multiple types of operations, such as, weed detection and elimination, tilling, harvesting, and controlling parameters of these operations based on the collected and processed information. Therefore, the imaging system 300 can provide solutions to multiple types of operations, thus minimizing the cost per operation.

The imaging system 300 optionally includes a wide lens and is positioned or oriented substantially in the horizontal axis. In an example, the imaging system 300 is configured to capture information from multiple wavelengths of the light spectrum. The imaging system 300 can detect, distinguish and identify field elements in a field with better accuracy, compared to standard RGB cameras, due to the ability to capture, isolate, and compare images from specific visible and invisible spectral bands. Using information about the same area but acquired in different bands or wavelengths of light, the imaging system 300 can much better distinguish plants from soil or other elements. Therefore, the imaging system 300 can detect plants and other field elements in a field from a greater distance compared to RGB cameras.

Furthermore, by comparing images in different wavelengths of the light spectrum, the image information is less affected by differences in lighting conditions, thus enabling the imaging system 300 to detect plants or weeds with improved reliability at a greater distance compared to RGB cameras. Thus, the presently disclosed technology provides the benefit over traditional RGB imaging systems, which are unable to detect small weeds at a distance.

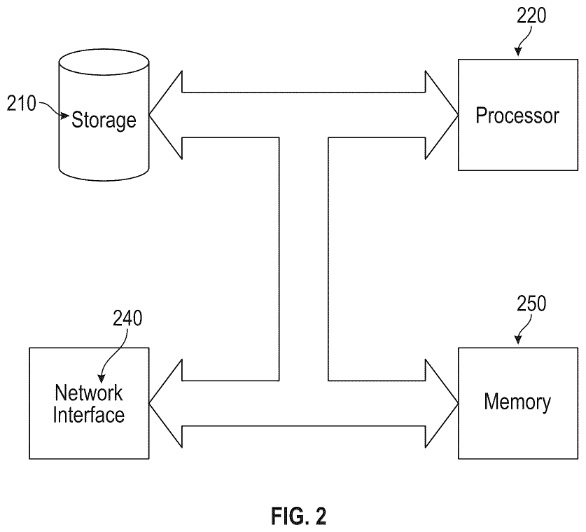

FIG. 2 illustrates one example of a controller 200 including a processor 220 connected to a computer-readable storage medium or a memory 230. The controller 200 may be used to control and/or execute operations of the imaging system 300. The computer-readable storage medium or memory 230 may be a volatile type of memory, e.g., RAM, or a non-volatile type of memory, e.g., flash media, disk media, etc. In various aspects of the disclosure, the processor 220 may be another type of processor, such as a digital signal processor, a microprocessor, an ASIC, a graphics processing unit (GPU), a field-programmable gate array (FPGA), or a central processing unit (CPU). In certain aspects of the disclosure, network inference may also be accomplished in systems that have weights implemented as memristors, chemically, or other inference calculations, as opposed to processors.

In aspects of the disclosure, the memory 230 can be random access memory, read-only memory, magnetic disk memory, solid-state memory, optical disc memory, and/or another type of memory. In some aspects of the disclosure, the memory 230 can be separate from the controller 200 and can communicate with the processor 220 through communication buses of a circuit board and/or through communication cables such as serial ATA cables or other types of cables. The memory 230 includes computer-readable instructions that are executable by the processor 220 to operate the controller 200. In other aspects of the disclosure, the controller 200 may include a network interface 240 to communicate with other computers or to a server. A storage device 210 may be used for storing data. The disclosed method may run on the controller 200 or on a user device, including, for example, on a mobile device, an IoT device, or a server system.

Referring to FIG. 3, an example of the imaging system 300 is shown. The illustrated example of the imaging system 300 generally includes an imaging sensor 302, such as can include a stereoscopic multispectral imaging sensor configured to capture real-time images at a plurality of wavelengths of light (e.g., visible light, near IR, IR, etc.), the controller 200 (see, e.g., FIG. 2), and an Inertial Measurement Unit (IMU) 306. In aspects, the imaging system 300 may include a GPS receiver 304. The stereoscopic multispectral imaging sensor 302 may include one or more sensors, for example, an infrared (IR) sensor, a red light sensor, and/or a sensor of another spectrum of light. In various aspects, the stereoscopic multispectral imaging sensor 302 may include one or more CMOS sensors. In various aspects, the imaging system 300 may include a light sensor 310 configured to detect ambient light levels. The controller 200 may use the captured ambient light levels to determine an index correction factor, such as for correcting or calibrating a vegetation index. The stereoscopic multispectral imaging sensor 302 may use ambient light as a light source and thus does not need an external light source. The stereoscopic multispectral imaging sensor 302 therefore can be considered a passive sensor because it uses ambient light as the light source.

The imaging system 300 is configured for capturing real-time images and/or video such as for at least the entire operating width of the agricultural machinery using multispectral imaging. Multispectral imaging involves capturing images of a scene or object over multiple discrete wavelength bands and extracting spectral content from that data. Multispectral imaging captures image data within wavelength ranges across the electromagnetic spectrum. The wavelengths may be separated by filters or detected with the use of components that are sensitive to particular wavelengths, including light from frequencies beyond the visible light range, i.e., IR and ultra-violet light.

The stereoscopic multispectral imaging sensor 302 enables detailed measurements of the morphology of the field to be acquired and/or calculated, as well as the position and orientation with respect to the part of the field scanned. The stereoscopic multispectral imaging sensor 302 is configured to provide distance and/or depth information for objects in the captured images. The stereoscopic multispectral imaging sensor 302 includes a wide-angle lens. The wide-angle lens (for example, an angle of view of about 90° to about 150°) is configured to encompass the entire operating width of the agricultural machinery (typically a width of about 20 to about 46 meters).

The imaging system 300 can use measurements acquired from the IMU 306 to improve the accuracy of measurements and calculations. The IMU 306 is configured to generate a signal indicating an acceleration, an angular rate, and/or orientation of the stereoscopic multispectral imaging sensor 302. In aspects, the stereoscopic multispectral imaging sensor 302 may include a gyroscope, a magnetometer, and/or an accelerometer. The IMU measurements may be used to improve the accuracy of the imaging system 300 measurements and calculations.

The GPS receiver 304 is configured to generate real-time location information for the captured images to increase the accuracy of the location of the field elements. The outcome of the above measurements and calculations provides an accurate determination of the location of the field elements 104, either relative to the vehicle 102 or positioned on an absolute scale, using the GPS receiver 304.

Referring to FIG. 4, a top view of the imaging system 300 mounted to the agricultural vehicle 102 is shown. By using a wide lens (e.g., about 120 degrees), the imaging system 300 has a field of view that encompasses the entire working width of the agricultural vehicle 102.

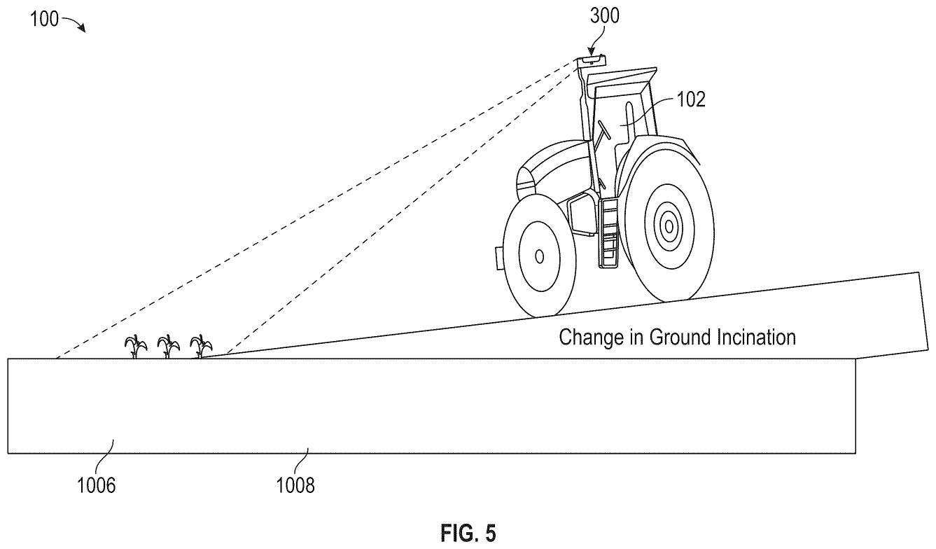

Referring to FIG. 5, a side view of a field 1008 with a change in ground incline is shown. The IMU 306 of the imaging system 300 enables accurate detection of the field elements 104 even when there is a change in ground incline by providing the angle and direction of the imaging system 300 relative to the field elements 104.

The present inventors have recognized that image-based object detection can be difficult, particularly for objects in the green or brown color spectrum. The present inventors have recognized that a solution can include or use information about which areas of a field were observed successfully by the system and how many times each area was observed. In an example, each image that is captured and processed successfully can be considered an additional observation of one or more areas in the camera's field of view.

In an example, the system can use the observation information to determine whether or to what extent to treat particular field areas (e.g., with pesticide, or other material). For example, unobserved areas can be treated with a fixed dosage, while other areas can be treated with a dosage tailored to the particular features observed in the field area. In some examples, an area observation count can be useful to filter-out false positives. For example, a single detection of a weed in one observation, for an area that has been observed multiple of times, can have a higher probability of being a false positive. Accordingly, the systems and methods discussed herein can use an observation count data structure to help track field features and identify areas for treatment.

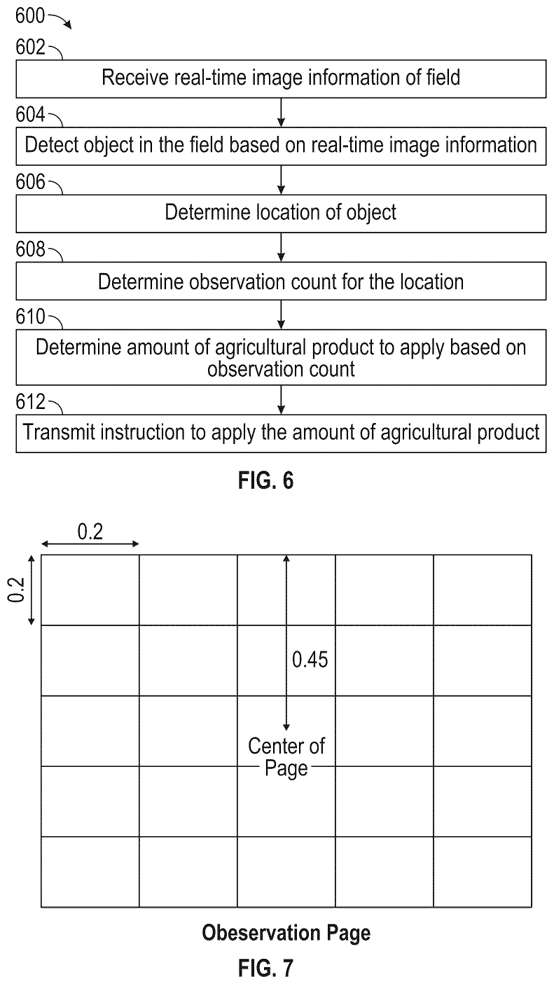

FIG. 6 show a flow diagram of a method 600 for controlling the amount of agricultural product to be applied based on observation counts, in accordance with aspects of the present disclosure. In an example, method 600 may be performed by the imaging system 300 as described above.

At operation 602, real-time image information is received. For example, the real-time image information may include multi-spectral information of a field from a multi-spectral imaging system positioned on an agricultural vehicle. In another example, the real-time image information may include images from a color image sensor.

At operation 604, an object in the field is detected based on the real-time image information. For example, a green on brown detection technique may be applied to the real-time image information to detect the object, such as a weed, using color differentiation.

At operation 606, a location of the object in the field is determined. In an example, the location may be determined based on GPS information.

At operation 608, an observation count for the location on the field where the object is detected is determined. The observation count (O) represents a number of times the location has been observed by the system. Also, the number of times the object has been detected (D) is also determined and maintained.

At operation 610, an amount of agricultural product to apply to the location by the agricultural vehicle is determined based on the observation count (O). In some examples, the amount of agricultural product to apply may also be based on the number of detections (D). The observation count may, for example, determine whether the object detection is a true detection or a false positive. For example, if a ratio of detections of the object to the observation count is greater than a threshold (T1), the detection may be considered a true positive (D/O>T1). If the ratio is equal to or less than the threshold, the detection may be considered a false positive. In some examples, if the number of detections is above a high value, such as a second threshold (T2), the detection is considered a true positive regardless of the observation count (D>T2). In the case of a false positive, the amount of agricultural product to be applied may be zero or another predetermined amount, such as a fixed dosage.

At operation 612, an instruction to apply the determined amount of the agricultural product for the location is transmitted to the agricultural vehicle. The agricultural vehicle may then apply the determined amount or not apply in the case of zero amount.

To maintain observation counts of areas near the agricultural vehicle, an observation matrix can be used. In an example, the observation matrix is a data structure of observation counts and can include a plurality of observation pages. For example, the observation matrix can include four observation pages. Each observation page maintains the observation counts for sub-regions of the imaged space around the agricultural vehicle as the vehicle traverses the field. The pages can be updated and recycled as the vehicle moves. As described in further detail below, the observation matrix can be stored in a local memory (e.g., memory 230 described above) to facilitate fast retrieval and processing.

In an example, an observation page is a N×N matrix where each cell in the matrix can include an observation count value. The observation count value can be provided in a range (e.g., 0-255). In an example, a “0” value indicates that the area is unobserved. A maximum value can be set for the maximum number of observation counts (e.g., 255) supported by the system. If an area is tracked more than the maximum number, the observation count value does not increment but is clamped at the maximum number.

FIG. 7 shows an example of an observation page 700, in accordance with aspects of the present disclosure. As shown, the observation page 700 includes a 5×5 matrix comprising 25 cells. The observation page 700 can include configuration parameters. For example, the configuration parameters can include a meters-per-cell parameter, which defines the real-word dimensions (meters x meters) that each cell represents. In the example of FIG. 7, the meters-per-cell parameter is set to 0.2. The configuration parameters can also include a scan radius, which defines the radius of a minimum area an observation page should maintain. Hence, the scan radius can set the dimensions of the observation page in rows and columns. In the example of FIG. 7, the scan radius is set to 0.45.

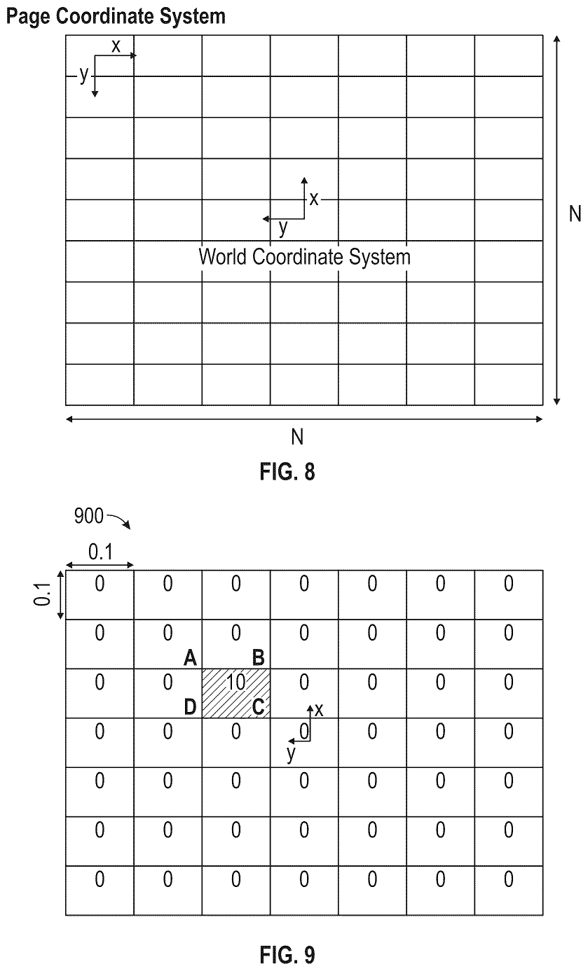

Position information from a real-world coordinate system (e.g., GPS) can be mapped or projected to the observation page cell coordinates. FIG. 8 shows an example of a page coordinate system 800, in accordance with aspects of the present disclosure. The page coordinate system 800 shows an application of a world coordinate system to page coordinates in a N×N matrix. For example, a 2D Affine transform can be applied from the world coordinate system to convert to page cell coordinates, or vice versa. Affine transformation is a linear mapping method that preserves points, straight lines, and planes.

FIG. 9 shows an example of an observation page 900, in accordance with aspects of the present disclosure. Observation page 900 shows observation counts for different cells. Four cells are labeled for reference, A, B, C, and D. The area in the observation page 900 can be defined in world coordinates within points. For example, A has a center point of (0.15, 0.15), B has center point of (0.15, 0.05), C has a center point of (0.05, 0.05), and D has a center point of (0.05, 0.15). C has a count of 10, which indicates that cell C has been observed 10 times while all other areas are still unobserved.

As mentioned above, an observation matrix can be stored in a local memory (e.g., memory 230) of an imaging system to facilitate fast retrieval and processing. The size of the local memory can be a limiting factor for the size of the observation matrix. Using observation pages can improve the efficiency of the local memory usage. The observation pages can be stored in the local memory and can be selectively activated based on the position of the agricultural vehicle, thus conserving use of the local memory. For example, data for active observation pages may be maintained and updated in the local memory (e.g., memory 230). Data for inactive observation pages may not be maintained in the local memory, thus saving memory space.

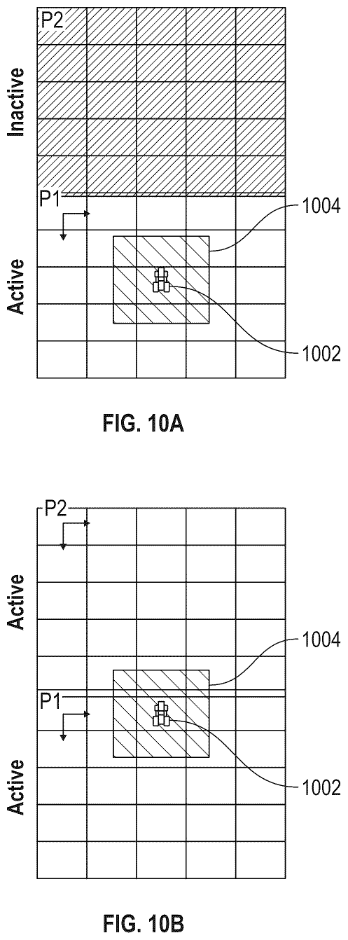

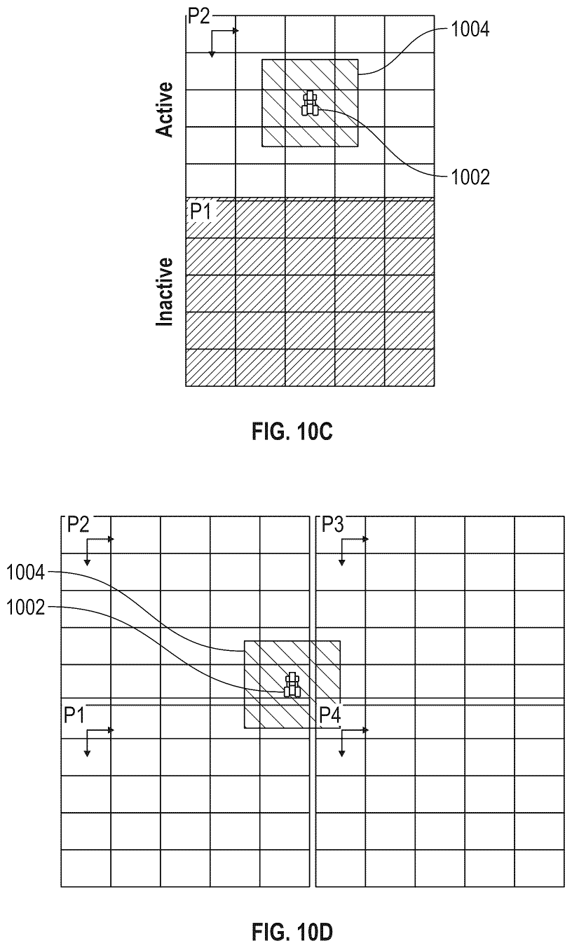

FIGS. 10A-10D show an example of selective activation of different observation pages in an observation matrix, in accordance with aspects of the present disclosure. A region of interest can be based on the imaging sensor, such as the range of the image sensor, and, optionally, an application footprint of the sprayer booms. In this example, the observation matrix includes four observation pages, P1, P2, P3, P4. An agricultural vehicle 1002 is shown, and a region of interest 1004 around the agricultural vehicle 1002 is shown.

In the example of FIG. 10A, the agricultural vehicle 1002 and the region of interest 1004 is located in only P1. P1 is activated because of the region of interest 1004 being located in P1, and P1 is maintained and updated in the local memory. Other pages, such as P2, are deactivated and therefore not maintained and updated in the local memory. In the example of FIG. 10B, the agricultural vehicle 1002 has moved but still remains in P1 while the region of interest 1004 now is located in both P1 and P2. Thus, P1 remains activated and P2 is now also activated. In the example of FIG. 10C, the agricultural vehicle 1002 continues its movement and the region of interest is in only P2. Thus, P1 has been deactivated because it no longer contains a portion of the region of interest 1004, and P2 remains activated.

In the example of FIG. 10D, the agricultural vehicle is located near the corner of all four pages, and region of interest 1004 intersects all four pages, P1, P2, P3, and P4. Thus, all four pages are activated.

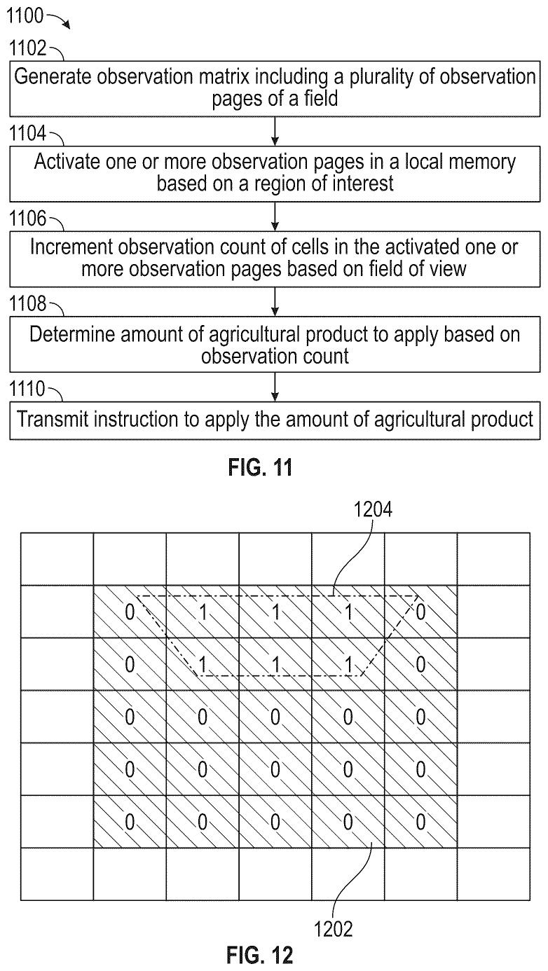

FIG. 11 shows a flow diagram of a method 1100 using observation pages to control the amount of agricultural product to be applied based on observation counts in accordance with aspects of the present disclosure. In an example, method 1100 may be performed by the imaging system 300 as described above.

At operation 1102, an observation matrix including a plurality of observation pages for a field is generated and stored in a local memory of the image system. The observation matrix is based on real-time image information. For example, the real-time image information may include multi-spectral information of a field from a multi-spectral imaging system positioned on an agricultural vehicle. In another example, the real-time image information may include images from a color image sensor.

At operation 1104, one or more observation pages are activated in the local memory based on the region of interest around the agricultural vehicle. The region of interest may be based on the range of the image sensor and, optionally, an application footprint of the spray booms of the agricultural vehicle. The one or more activated observation pages correspond to the observation pages which intersect at least partially with the region of interest.

At operation 1106, incrementing observation count of cells in the activated one or more observation pages based on the field of view of the imaging system. A field of view represents the area that the image sensor can observe. The observation count of cells within the field of view of the activated observation pages are incremented while the observation count of the other cells is not incremented. Moreover, objects within the field of view may be detected based on the real-time image information as described herein. For example, a green on brown detection technique may be applied to the real-time image information to detect objects, such as a weed.

At operation 1108, an amount of agricultural product to apply to the location defined by the field of view is determined based on the observation count. In some examples, the amount of agricultural product to apply may also be based on object detections as described herein.

At operation 1110, an instruction to apply the determined amount of the agricultural product for the location is transmitted to the agricultural vehicle.

FIG. 12 shows an example of using a field of view to increment observation counts, in accordance with aspects of the present disclosure. In FIG. 12, a region of interest 1202 is shown as well as a field of view 1204. Here, the field of view 1204 can be represented as a convex polygon area (e.g., convex quadrilateral). When updating the observation matrix, the values of the cells inside the field of view 1204 are incremented. In some examples, a cell is considered inside the field of view 1204 if the center of the cell is inside the area of field of view 1204 (e.g., inside the illustrated polygon area).

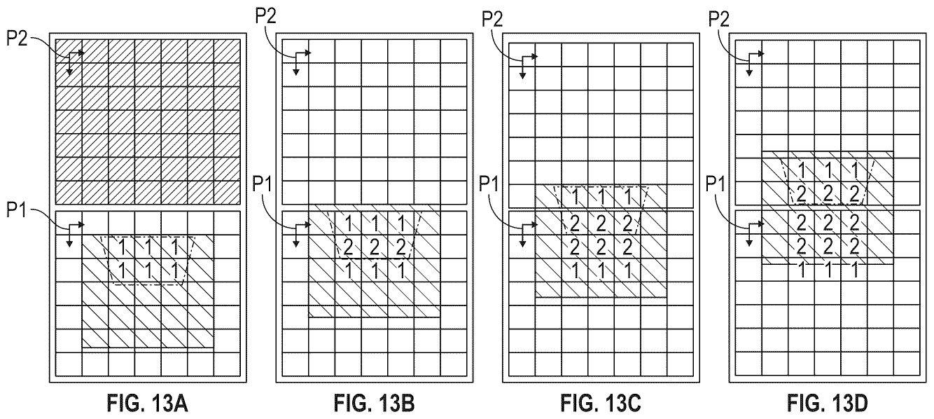

FIGS. 13A-13D show an example of using observation counts based on a field of view as an agricultural vehicle traverses a field, in accordance with aspects of the present disclosure. In FIG. 13A, observation page P1 is activated because a region of interest 1302 is located in P1. Other observation pages, such as P2, are not activated because a lack of intersection with the region of interested 1302. A field of view 1304 shows cells within P1 in which observation counts are incremented at t1. In this example, this is the first time the cells in the field of view 1304 are observed so the observation count of all the pixels in the field of view 1304 are incremented to “1”.

FIG. 13B shows the position of agricultural vehicle at t2. Now, portions of the region of interest 1302 now reside in both P1 and P2, and both P1 and P2 are activated. The field of view 1304 has also moved based on the movement of the agricultural vehicle. At t2, observation counts of cells within the field of view 1304 are updated. One row, which was also within the field of view 1304 at t1, has been incremented to value “2”. The new row of pixels in the field of view 1304 in the field of view are incremented to a value of “1”.

The agricultural vehicle continues its movement, and FIG. 13C shows the position of the agricultural vehicle at t3. P1 and P2 remain activated because the region of interest 1302 intersects with P1 and P2. The field of view 1304 has also moved based on the movement of the agricultural vehicle. At t3, observation counts of cells within the field of view 1304 are updated. One row, which was also within the field of view 1304 at t2 but not at t1, has been incremented to value “2”. The new row of pixels in the field of view 1304 in the field of view are incremented to a value of “1”.

The agricultural vehicle continues its movement, and FIG. 13D shows the position of the agricultural vehicle at t4. P1 and P2 remain activated because the region of interest 1302 intersects with P1 and P2 (even though the field of view 1304 is now entirely within P2). The field of view 1304 has also moved based on the movement of the agricultural vehicle. At t4, observation counts of cells within the field of view 1304 are updated. One row, which was also within the field of view 1304 at t3 but not at t2 or t1, has been incremented to value “2”. The new row of pixels in the field of view 1304 in the field of view are incremented to a value of “1”.

In some examples, the observation matrix is queried to determine observation count(s) for a particular area, such as the working area of a nozzle. The area may include one or more cells in the observation matrix. In some examples, the observation matrix is queried by providing as an input a batch of convex polygon areas corresponding to the areas of interest. For example, the polygon areas can represent the working area of each nozzle of the boom. The observation matrix can also be queried by providing as an input a batch of points. Polygons can be used when querying areas corresponding to nozzles. Points can be used when querying for a localized weed or other object. For example, if the working area of a nozzle is determined to be unobserved, then a fixed dosage (e.g., zero amount) may be applied. In some examples, the polygons can represent an area around a localized weed. If a ratio of detections to observations in the area around the weed is low (e.g., below a threshold), then the detection of the weed has a high probability of being a false positive. For each area, the results can be represented as observed area (m×m) inside the polygon that was observed at least one time in the observation matrix.

In some examples, the results can include average observations, which is the average number of observations for observed cells. In some examples, to consider that an area is observed, two conditions may be satisfied:

$$Average\_observations \geq \text{a threshold} ( \text{e.g.} , 4 ) ; \qquad 1 )$$

$$and$$

$$Observed\_Area / Query\_Area \geq area\_threshold ( \text{e.g.} , 80 \% ) \qquad 2 )$$

Otherwise, the area can be classified as unobserved.

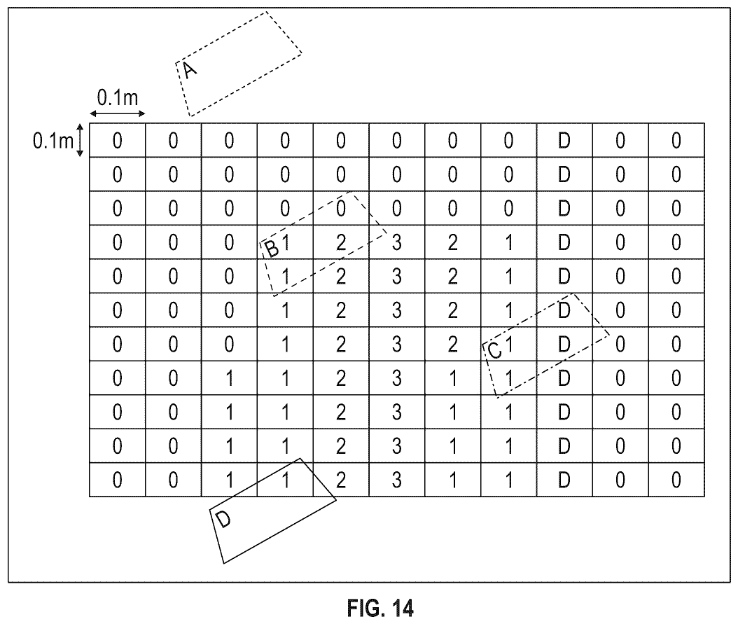

FIG. 14 shows an illustration example of querying an observation matrix of for a plurality of areas, in accordance with aspects of the present disclosure. Each cell in the observation matrix has a size of 0.1 m×0.1 m. FIG. 14 shows four areas, A, B, C, and D. In some examples, the areas may represent nozzle locations attached to the agricultural vehicle. For area A, there are no cells with an observation count.

For area B, two cells have an observation count of 1 and one cell has an observation count of 2. For area B:

Observed Area: 3×(0.1×0.1)=0.03 m²

Average Observations: (1+1+2)/3=1.33

If a threshold value of “1” is set for average observation, then area B is determined as an observed area because 1.33 is greater than the threshold value of 1.

For area C, two cells have an observation count of 1. For area C:

Observed Area: 2×(0.1×0.1)=0.02 m²

Average Observations: (1+1)/2=1.00

If a threshold value of “1” is set for average observation, then area C is determined as an unobserved area because the average observations is not greater than the threshold value of 1.

For area D, one cell has an observation count of 1. For area D:

Observed Area: 1×(0.1×0.1)=0.01 m²

Average Observations: 1/1=1.00

If a threshold value of “1” is set for average observation, then area D is determined as an unobserved area because the average observations is not greater than the threshold value of 1.

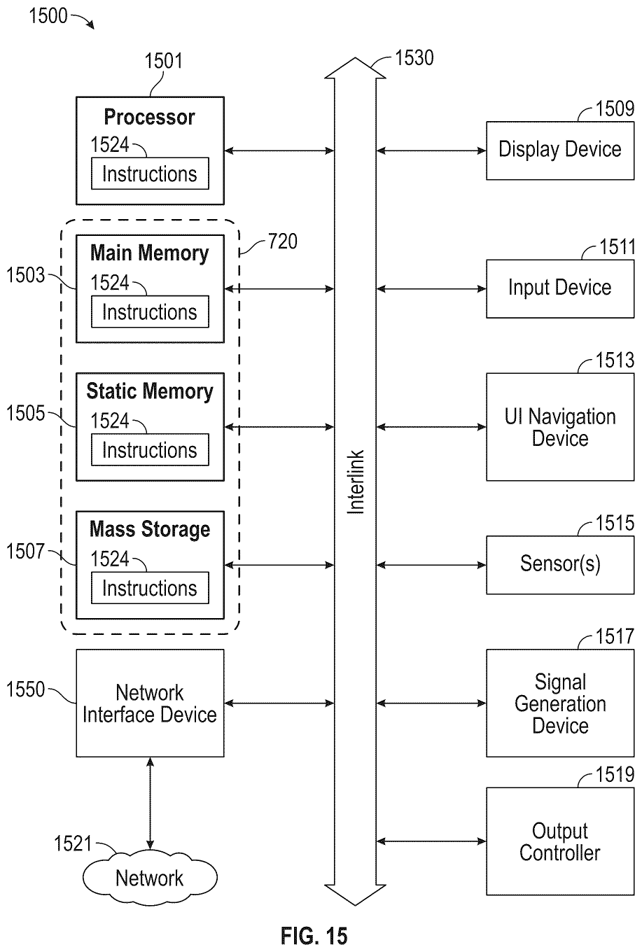

The techniques shown and described in this document can be performed using a portion or an entirety of the imaging system as described above or otherwise using a machine 1500 as discussed below in relation to FIG. 15. FIG. 15 illustrates a block diagram of an example comprising a machine 1500 upon which any one or more of the techniques (e.g., methodologies) discussed herein may be performed. In various examples, the machine 1500 may operate as a standalone device or may be connected (e.g., networked) to other machines.

In a networked deployment, the machine 1500 may operate in the capacity of a server machine, a client machine, or both in server-client network environments. In an example, the machine 1500 may act as a peer machine in peer-to-peer (P2P) (or other distributed) network environment. The machine 1500 may be a personal computer (PC), a tablet device, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware comprising the circuitry may include variably connected physical components (e.g., execution units, transistors, simple circuits, etc.) including a computer-readable medium physically modified (e.g., magnetically, electrically, such as via a change in physical state or transformation of another physical characteristic, etc.) to encode instructions of the specific operation. In connecting the physical components, the underlying electrical properties of a hardware constituent may be changed, for example, from an insulating characteristic to a conductive characteristic or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 1500 (e.g., computer system) may include a hardware-based processor 1501 (e.g., a central processing unit (CPU), a graphics processing unit (GPU), a hardware processor core, or any combination thereof), a main memory 1503 and a static memory 1505, some or all of which may communicate with each other via an interlink 1530 (e.g., a bus). The machine 1500 may further include a display device 1509, an input device 1511 (e.g., an alphanumeric keyboard), and a user interface (UI) navigation device 1513 (e.g., a mouse). In an example, the display device 1509, the input device 1511, and the UI navigation device 1513 may comprise at least portions of a touch screen display. The machine 1500 may additionally include a storage device 1520 (e.g., a drive unit), a signal generation device 1517 (e.g., a speaker), a network interface device 1550, and one or more sensors 1515, such as a global positioning system (GPS) sensor, compass, accelerometer, or other sensor. The machine 1500 may include an output controller 1519, such as a serial controller or interface (e.g., a universal serial bus (USB)), a parallel controller or interface, or other wired or wireless (e.g., infrared (IR) controllers or interfaces, near field communication (NFC), etc., coupled to communicate or control one or more peripheral devices (e.g., a printer, a card reader, etc.).

The storage device 1520 may include a machine readable medium on which is stored one or more sets of data structures or instructions 1524 (e.g., software or firmware) embodying or utilized by any one or more of the techniques or functions described herein. The instructions 1524 may also reside, completely or at least partially, within a main memory 1503, within a static memory 1505, within a mass storage device 1507, or within the hardware-based processor 1501 during execution thereof by the machine 1500. In an example, one or any combination of the hardware-based processor 1501, the main memory 1503, the static memory 1505, or the storage device 1520 may constitute machine readable media.

While the machine readable medium is considered as a single medium, the term “machine readable medium” may include a single medium or multiple media (e.g., a centralized or distributed database, and/or associated caches and servers) configured to store the one or more instructions 1524.

The term “machine readable medium” may include any medium that is capable of storing, encoding, or carrying instructions for execution by the machine 1500 and that cause the machine 1500 to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The instructions 1524 may further be transmitted or received over a communications network 1521 using a transmission medium via the network interface device 1550 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., the Institute of Electrical and Electronics Engineers (IEEE) 802.22 family of standards known as Wi-Fi®, the IEEE 802.26 family of standards known as WiMax®), the IEEE 802.27.4 family of standards, peer-to-peer (P2P) networks, among others. In an example, the network interface device 1550 may include one or more physical jacks (e.g., Ethernet, coaxial, or phone jacks) or one or more antennas to connect to the communications network 1521. In an example, the network interface device 1550 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1500, and includes digital or analog communications signals or other intangible medium to facilitate communication of such software.

### Various Notes and Aspects

Aspect 1 can include subject matter such as a method comprising: receiving real-time image information of a field from an multi-spectral imaging system positioned on an agricultural vehicle; determining, by at least one hardware processor, an observation count for a location in the field, wherein the observation count represents a number of times the location has been observed by the multi-spectral imaging system; and determining an amount of an agricultural product to apply to the location by the agricultural vehicle based on the observation count; and transmitting an instruction to apply the amount of the agricultural product for the location by the agricultural vehicle.

Aspect 2 can include, or can optionally be combined with the subject matter of Aspect 1, to optionally include wherein when the observation count is less than a threshold, determining the amount to be a fixed amount of the agricultural product.

Aspect 3 can include, or can optionally be combined with the subject matter of one or any combination of Aspects 1 or 2 to optionally include wherein the fixed amount is zero.

Aspect 4 can include, or can optionally be combined with the subject matter of one or any combination of Aspects 1-3 to optionally include detecting at least one object in the field based on the real-time image information; and determining that the at least one object in the field is present in the location of the field.

Aspect 5 can include, or can optionally be combined with the subject matter of one or any combination of Aspects 1-4 to optionally include wherein when a ratio of the observation count and a number of detections of the at least on object is less than or equal to a threshold, determining that detection of the at least on object is a false positive.

Aspect 6 can include, or can optionally be combined with the subject matter of Aspects 1-5 to optionally include wherein determining observation count of the area in the field is based on GPS information.

Aspect 7 can include, or can optionally be combined with the subject matter of Aspects 1-6 to optionally include generating an observation matrix based on the real-time image information, the observation matrix including a plurality of cells, wherein each cell of the plurality of cells represents a respective area of the field, and wherein the location is represented by a respective cell of the plurality of cells.

Aspect 8 can include, or can optionally be combined with the subject matter of Aspects 1-7 to optionally include wherein the observation matrix includes n number of observation pages stored in a local memory.

Aspect 9 can include, or can optionally be combined with the subject matter of Aspects 1-8 to optionally include wherein a respective observation page of the n number of observation pages is activated in the local memory when a region of interest for the agricultural vehicle is located in the respective observation page.

Aspect 10 can include, or can optionally be combined with the subject matter of Aspects 1-9 to optionally include incrementing the observation count when the location is within a field of view of the imaging system.

Aspect 11 can include, or can optionally be combined with the subject matter of Aspects 1-10 to optionally include wherein the imaging system includes a multi-spectral imaging system with at least one passive imaging sensor using ambient light as a light source.

Aspect 12 can include, or can optionally be combined with the subject matter of Aspects 1-11 to optionally include wherein the imaging system is mounted on top of a cabin of the agricultural vehicle.

Aspect 13 can include subject matter such as a system comprising: one or more processors of a machine; and a memory storing instructions that, when executed by the one or more processors, cause the machine to perform operations implementing any one of Aspects 1-12.

Aspect 14 can include subject matter such as machine-readable storage device embodying instructions that, when executed by a machine, cause the machine to perform operations implementing any one of Aspects 1-12.

Each of these non-limiting aspects can stand on its own, or can be combined in various permutations or combinations with one or more of the other aspects.

It is to be understood that the steps of the methods described herein are performed by the controller upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller described herein, such as the methods described herein, is implemented in software code or instructions which are tangibly stored on a tangible computer readable medium. The controller loads the software code or instructions via a direct interface with the computer readable medium or via a wired and/or wireless network. Upon loading and executing such software code or instructions by the controller, the controller may perform any of the functionality of the controller described herein, including any steps of the methods described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method aspects or examples described herein can be machine or computer-implemented at least in part. Some aspects or examples can include a computer-readable medium or machine-readable medium encoded with instructions operable to configure an electronic device to perform methods as described in the above aspects or examples. An implementation of such methods can include code, such as microcode, assembly language code, a higher-level language code, or the like. Such code can include computer readable instructions for performing various methods. The code may form portions of computer program products. Further, in an aspect or example, the code can be tangibly stored on one or more volatile, non-transitory, or non-volatile tangible computer-readable media, such as during execution or at other times. Aspects or examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method comprising:
receiving real-time image information of a field from an imaging system positioned on an agricultural vehicle;
determining, by at least one hardware processor, an observation count for a location in the field, wherein the observation count represents a number of times the location has been observed by the imaging system;
determining an amount of an agricultural product to apply to the location by the agricultural vehicle based on the observation count; and
transmitting an instruction to apply the amount of the agricultural product for the location by the agricultural vehicle.

2. The method of claim 1, wherein when the observation count is less than a threshold, determining the amount to be a fixed amount of the agricultural product.

3. The method of claim 2, wherein the fixed amount is zero.

4. The method of claim 1, further comprising:
detecting at least one object in the field based on the real-time image information; and
determining that the at least one object in the field is present in the location of the field.

5. The method of claim 4, wherein when a ratio of the number of detections of the at least on object to the observation count of the area is less than or equal to a threshold, determining that detection of the at least on object is a false positive.

6. The method of claim 4, wherein determining observation count of the location in the field is based on GPS information.

7. The method of claim 1, further comprising:
generating an observation matrix based on the real-time image information, the observation matrix including a plurality of cells, wherein each cell of the plurality of cells represents a respective area of the field, and wherein the location is represented by a respective cell of the plurality of cells.

8. The method of claim 7, wherein the observation matrix includes n number of observation pages stored in a local memory.

9. The method of claim 8, wherein a respective observation page of the n number of observation pages is activated in the local memory when a region of interest for the agricultural vehicle is located in the respective observation page.

10. The method of claim 9, further comprising:
incrementing the observation count when the location is within a field of view of the imaging system.

11. The method of claim 1, wherein the imaging system includes a multi-spectral imaging system with at least one passive imaging sensor using ambient light as a light source.

12. The method of claim 1, wherein the imaging system is mounted on top of a cabin of the agricultural vehicle.

13. A machine-storage medium embodying instructions that, when executed by a machine, cause the machine to perform operations comprising:
receiving real-time image information of a field from an imaging system positioned on an agricultural vehicle;
determining, by at least one hardware processor, an observation count for a location in the field, wherein the observation count represents a number of times the location has been observed by the imaging system;
determining an amount of an agricultural product to apply to the location by the agricultural vehicle based on the observation count; and
transmitting an instruction to apply the amount of the agricultural product for the location by the agricultural vehicle.

14. The machine-storage medium of claim 13, wherein when the observation count is less than a threshold, determining the amount to be a fixed amount of the agricultural product.

15. The machine-storage medium of claim 14, wherein the fixed amount is zero.

16. The machine-storage medium of claim 13, the operations further comprising:
detecting at least one object in the field based on the real-time image information; and
determining that the at least one object in the field is present in the location of the field.

17. The machine-storage medium of claim 16, wherein when a ratio of the number of detections of the at least on object to the observation count of the area is less than or equal to a threshold, determining that detection of the at least on object is a false positive.

18. The machine-storage medium of claim 16, wherein determining observation count of the location in the field is based on GPS information.

19. The machine-storage medium of claim 13, the operations further comprising:
generating an observation matrix based on the real-time image information, the observation matrix including a plurality of cells, wherein each cell of the plurality of cells represents a respective area of the field, and wherein the location is represented by a respective cell of the plurality of cells.

20. The machine-storage medium of claim 19, wherein the observation matrix includes n number of observation pages stored in a local memory.

21. The machine-storage medium of claim 20, wherein a respective observation page of the n number of observation pages is activated in the local memory when a region of interest for the agricultural vehicle is located in the respective observation page.

22. The machine-storage medium of claim 21, the operations further comprising:
incrementing the observation count when the location is within a field of view of the imaging system.

23. The machine-storage medium of claim 13, wherein the imaging system includes a multi-spectral imaging system with at least one passive imaging sensor using ambient light as a light source.

24. The machine-storage medium of claim 13, wherein the imaging system is mounted on top of a cabin of the agricultural vehicle.

25. A system comprising:
at least one hardware processor; and
at least one memory storing instructions that, when executed by the at least one hardware processor, cause the at least one hardware processor to perform operations comprising:
receiving real-time image information of a field from an imaging system positioned on an agricultural vehicle;
determining, by at least one hardware processor, an observation count for a location in the field, wherein the observation count represents a number of times the location has been observed by the imaging system;
determining an amount of an agricultural product to apply to the location by the agricultural vehicle based on the observation count; and
transmitting an instruction to apply the amount of the agricultural product for the location by the agricultural vehicle.

26. The system of claim 25, wherein when the observation count is less than a threshold, determining the amount to be a fixed amount of the agricultural product.

27. The system of claim 26, wherein the fixed amount is zero.

28. The system of claim 25, the operations further comprising:
detecting at least one object in the field based on the real-time image information; and
determining that the at least one object in the field is present in the location of the field.

29. The system of claim 28, wherein when a ratio of the number of detections of the at least on object to the observation count of the area is less than or equal to a threshold, determining that detection of the at least on object is a false positive.

30. The system of claim 28, wherein determining observation count of the location in the field is based on GPS information.

31. The system of claim 24, the operations further comprising:
generating an observation matrix based on the real-time image information, the observation matrix including a plurality of cells, wherein each cell of the plurality of cells represents a respective area of the field, and wherein the location is represented by a respective cell of the plurality of cells.

32. The system of claim 31, wherein the observation matrix includes n number of observation pages stored in a local memory.

33. The system of claim 32, wherein a respective observation page of the n number of observation pages is activated in the local memory when a region of interest for the agricultural vehicle is located in the respective observation page.

34. The system of claim 33, the operations further comprising:
incrementing the observation count when the location is within a field of view of the imaging system.

35. The system of claim 24, wherein the imaging system includes a multi-spectral imaging system with at least one passive imaging sensor using ambient light as a light source.

36. The system of claim 24, wherein the imaging system is mounted on top of a cabin of the agricultural vehicle.
